(19) United States
(12) Patent Application Publication
(10) Pub. No.: US 2023/0370276 A1
(43) Pub. Date: Nov. 16, 2023

(54) Method of implementing Blockchain network utilizing always connected Internet Gateways (Routers) as nodes for offering the decentralized secured storage and other services.

(71) Applicant: Gryphon Online Safety, Inc., San Diego, CA (US)

(72) Inventors: Navin Kumar Gutti, Hyderabad (IN); Arup Bhattacharya, San Diego, CA (US); John Jun Wu, San Diego, CA (US)

(21) Appl. No.: 18/197,053

(22) Filed: May 13, 2023

Related U.S. Application Data
(60) Provisional application No. 63/341,419, filed on May 13, 2022.

(51) Int. Cl. H04L 9/32; H04L 9/40; H04L 67/1097; H04L 45/44

(52) U.S. Cl. CPC H04L 9/3239; H04L 9/40; H04L 67/1097; H04L 45/44

(57) ABSTRACT

The MetaSafe platform disclosed in this application is a decentralized storage and peer-to-peer network that utilizes Internet Gateway's (Routers) resources such as processor, storage, and network bandwidth to run a Blockchain network and provides services such as decentralized secured storage and peer-to-peer internet traffic routine for privacy that enables anyone with an Internet connection to store their information securely from any computing device and retrieve it on demand or share it at will. Due to its decentralized nature, and no single authority controlling or running the network, data is almost hackproof and not subject to any commercial exploitation. The enhancements comprise Proof of Stake consensus protocol vs. Proof of work to make it low-cost participation, utility token to incentivize the developers and network validators, and finally the ability to run the network validation on thousands of routers, the most under-utilized but the most important piece of hardware that's always online.

### RELATED APPLICATIONS

This application is related to the following:
a. Provisional Application Ser. No. 63/341,419, filed May 13, 2022 (Provisional).

This application claims priority to Provisional and hereby claims benefit of the filing date of each thereof pursuant to 37 CFR § 1.78(a)(4).

The subject matter of the Provisional in its entirety, is expressly incorporated herein.

### FIELD OF THE INVENTION

The present invention generally relates to utilizing Internet Gateway's (Routers) resources such as processor, storage, and network bandwidth to run a Blockchain network and providing services such as decentralized secured storage and peer-to-peer internet traffic routine for privacy.

### BACKGROUND OF INVENTION

With the advent of the Internet (Web 2.0), every day we are storing our information on networks and becoming increasingly vulnerable to hacking and giving away our information with others for their profit. Every time we create an online account, visit a doctor's office, call our insurance company, or just purchase something online, we are giving away our personal information, which often surfaces on the dark web. The major drawback of Web2.0 is all the information is stored in a centrally located public or private server, making it prone to hacking and controlled by corporations with a vested interest in our information.

The current method of storing personal data such as web credentials, credit cards information, or medical data are mostly stored on papers by the users or locally on a computer, mobile devices or in best case on the servers connected over Internet but mostly at a central location.

All the above methods are highly insecure as: a) data is stored in a centralized location; b) data is not properly safeguarded by encryption technology and thus prone to be hacked, subject to ransomware attack or stolen by data collectors; c) data can be accessed and breached by the employees of companies providing services.

The Blockchain technology solves the above problems by keeping the data in an encrypted, de-centralized location, on self-running networks making it difficult to hack through implementation of advanced encryption standards along requirements of proof of work or proof of stake.

However, the hardware to participate on a Blockchain network running proof of work, are expensive and thus higher price is associated with use of such a network.

Therefore, there exists a need for a system and method that: (a) stores the personal data on a decentralized network like Blockchain, utilizing low-cost hardware that is always connected such as Internet Gateways (Routers) and implement the proof of stake algorithm; (b) enhances the storage offered by Internet Gateways with network attached storage (NAS); (c) enhances the storage offered by Internet Gateways through mechanisms such as using the interplanetary file system; and (d) stores the critical block data and indexes on the main chain and stores the other data as chunks in decentralized fashion on side chains or off chain storage systems.

Web3.0 has proved the immense advantage of a decentralized network and has shown the way to achieve that. Ethereum and other Blockchain technologies used to safeguard cryptocurrency like bitcoin has a proven track record of security and has demonstrated the value of decentralized Smart Contract-based transaction ledger without a central authority. The most adopted consensus algorithm proof-of-work has been used so far to make the network secure and keep the bad actors out. However, the hardware cost to run such an algorithm is very high and is the main factor prohibiting the mass adoption of the software technology in areas other than crypto.

MetaSafe breaks that barrier to enable mass adoption of Web 3.0.

### BRIEF SUMMARY OF THE INVENTION

The MetaSafe platform disclosed in this application is a decentralized storage and peer-to-peer network that enables anyone with an Internet connection to store their information securely from any computing device and retrieve it on demand or share it at will. Due to its decentralized nature, and no single authority controlling or running the network, data is almost hackproof and not subject to any commercial exploitation. To achieve this, MetaSafe uses Blockchain, the same technology that safeguards Cryptocurrency with some amount of enhancement and moderation. The enhancement comprises Proof of Stake consensus protocol vs. Proof of work to make it low-cost participation, utility token to incentivize the developers and network validators, and finally the ability to run the network validation on thousands of routers, the most under-utilized but the most important piece of hardware that's always online.

The secure, low cost, low power, and open platform may enable other developers to develop applications to defend the data security and privacy of billions of Internet users and get rewarded for their efforts. MetaSafe network makes these applications available to all, being the first decentralized Blockchain network of its kind.

### BRIEF SUMMARY OF THE INVENTION

MetaSafe, being a Blockchain network may execute Smart Contracts, run MetaSafe consensus algorithm, reward MetaSafe utility tokens (MST), and provide an open platform to deploy applications to defend data security and privacy, such as password managers and other utility applications.

The MetaSafe consensus algorithm may utilize proof-of-storage and proof-of-network-bandwidth. The miners being the backbone of MetaSafe Blockchain, may participate in the network by simply setting up a MetaSafe enabled router, thus providing the evidence of ownership of physical hardware (verifiable by the unique MAC address of the router) matched with their BIP32 wallet consisting of Public and Private Key which are needed to satisfy the requirements of proof of stake of storage, and network bandwidth. As the encrypted data along with open transaction information are submitted by miners, the members of the consensus group (validators), elected by the main chain, may approve to create a new block and the data maybe written into the network at the selected block location by the validators. The Open platform API compatible with JSONRPC protocol may provide the means of writing users' data with a paid account. The miners maybe rewarded for creating and validating data to be written in such blocks containing the transaction data.

### BRIEF DESCRIPTION OF DRAWINGS

FIG. 1 illustrates in block diagram form a Blockchain network implemented using internet gateways as nodes in an embodiment of the invention.

FIG. 2 illustrates the components and steps involved in storing some data from a device onto the Blockchain network in an embodiment of the invention.

FIG. 3 illustrates the components and steps involved in retrieving data by a device from the Blockchain network in an embodiment of the invention.

FIG. 4 is an illustration of the basic building blocks of a block on the Blockchain in an embodiment of the invention.

FIG. 5 illustrates in a block diagram the basic components in a validator node in an embodiment of the invention.

FIG. 6 illustrates in a block diagram the basic components Blockchain network in an embodiment of the invention.

FIG. 7 illustrates in a flow chart form the transaction flow in a router based Blockchain network in an embodiment of the invention.

### DETAILED DESCRIPTION

The invention is a system and method of implementing low-cost Blockchain network utilizing always connected routers to store personal data securely and/or for other purposes.

An embodiment of the MetaSafe network platform may be developed using following basic components:
a. A Blockchain designed to offer “Decentralization”, “Immutability”, “Verifiability”, “Pseudo anonymity” and “Trust less” features. The Blockchain maybe based on Ethereum but specifically modified to operate on low-cost hardware with additional consensus mechanisms.
b. Consensus algorithms, such as Proof-of-stake, Proof-of-storage, Proof-of-bandwidth.
c. Smart Contracts.
d. Utility tokens to incentivize miners and application developers.
e. Validators nodes which function as the backbone of MetaSafe network provide the storage, connectivity and computing used for the Blockchain. In certain embodiments, the preferred mechanism to run a validator node may be to setup a MetaSafe enabled router using the MetaSafe mobile app.
f. Beacon chain, as the main chain of MetaSafe network may be responsible for electing a proposer and set of validators for the respective slots in the main chain and as well as Shard chains. Beacon chain may keep track of the stake and reward tokens when a block is added. It may impose bad actor policies or eliminating nodes that do not meet the requirement (such as on time etc.).
g. Shard chains, which are the parallel Blockchain networks that work with Beacon chain to have horizontal scaling on the MetaSafe network, may be used to improve scalability of the Blockchain. A certain embodiment of MetaSafe employs 4 Shards, where Shard 0 is the main chain and Shards 1, 2, and 3 are Shard chains. Validators and proposers maybe randomly assigned to a Shard chains as they join the network and at each epoch.
h. Epoch is the regular interval at which the selection and sorting of validators along with the rewarding and slashing operations may take place.
i. Interplanetary file system (IPFS) may be used to provide the true decentralized storage system which the MetaSafe Network may use to save off-chain information.
j. Enabling devices with Network File Systems (NFS) may extend the storage requirements of the devices by enabling them to store the on-chain and off chain (using Interplanetary File System—IPFS) data.
k. Metasafe network may support cross chain and bridge transactions which may enable MetaSafe network to work with multiple chains.
l. PeerToPeer Networking may enable the nodes to communicate between themselves without any need for centralized controller or coordinating systems.
m. Decentralized applications may use JavaScript Object Notation Remote Procedure Call (JSONRPC) and Web3 application programming interfaces (APIs) to interact with Metasafe network.

In embodiments, the router owners may be service providers or miners. The users may use the services offered, such as storing personal data on network. The service providers (router owners) may provide resources such as processor, storage, and network bandwidth to run the network and get incentivized through proof of stake.

Proof-of-Stake (POS) which may further comprise MST, the utility tokens for the network, may be used for consensus, instead of the expensive Proof-of-Work (POW). The network maybe operated through the use of (but not limited to) WiFi routers that enable MetaSafe, such as Gryphon 6e, which removes the need for other expensive hardware.

Proof-of-stake reduces the amount of computational work needed to verify blocks and transactions that keep the Blockchain, and thus a token or cryptocurrency, secure. Proof-of-stake changes the way blocks are verified using the machines of token or coin owners. The owners offer their tokens or coins as collateral for the chance to validate blocks. Token or coin owners with staked tokens or coins become “validators” and “proposers.”

Validators and proposers maybe selected randomly to “mine (propose),” or validate the block. This system may randomize who gets to “mine (propose)” rather than using a competition-based mechanism like proof-of-work.

Validator's hardware requirements become lot less demanding as compared to generic Blockchains, which allows for the network implementation to be much more environmentally friendly. Validators may earn up to a percent of revenues as tokens by providing storage and sharing network bandwidth. Validators may also earn newly minted tokens for blocks that they create, if they are part of consensus group.

The MetaSafe system may implement POS based on “proof-of-storage” and “proof-of-bandwidth” to ensure that the validators are legitimate.

The proof of stake algorithm is an algorithm where the validators will be selected at random depending on the number of MSTs staked instead of burning energy to solve a cryptographic puzzle. The staking contract is present on the Beacon chain where the validators will be depositing the tokens and participating.

In addition to staking MSTs, the validator must also offer storage space for storing the Blockchain. The system has to offer at least 8 GB of storage to be considered a suitable validator. This will be checked at each slot.

Another requirement to be a validator is the amount of bandwidth that is available to the system. The minimum bandwidth that's required is (for example) 100 mbps down and 10 mbps up. This will be checked at each epoch. Upload bandwidth should also be good as most of the time end users will be retrieving the data and validators have to push the results as soon as possible to the network to avoid the slot seal deadline.

To expand the network storage miners may use NAS drives and Interplanetary File System (IPFS) which enables off-chain storing and sharing of data in a distributed system. Shards are used so that each network does not need to store all blocks in the chain, allowing MetaSafe storage requirements to be scalable and performance optimized.

Decentralized storage offers data redundancy which may help recover the data in case of nodes lost in a single region or few regions. Data that is stored on chain and off chain maybe encrypted and protected by industry standard encryption and hashing algorithms to protect the data against unauthorized modifications.

The users of services incentivize the service providers directly by the network. Developers may develop applications which can be deployed over the network to accomplish business use cases. Application developers may earn MST by deploying applications on MetaSafe network. Open APIs that are compatible with various Blockchains and applications provide freedom for developers to develop and deploy applications which are not governed by any centralized authority.

The network may run Smart Contracts to establish the transaction rules. Smart Contracts prevent unauthorized access to the data stored on the network. Smart Contracts may also provide data sharing features such as sharing with another entity with specified time interval as provided by the user.

MetaSafe platform may also be used to implement a password manager app to store and autofill user ID, passwords, addresses, credit card information and such other basic information needed for a transaction to take place. The data for the password manager maybe distributed across the distributed network and stored as encrypted data packets making it secure and out of reach of hackers to obtain access to accounts and systems by hacking the password manager database.

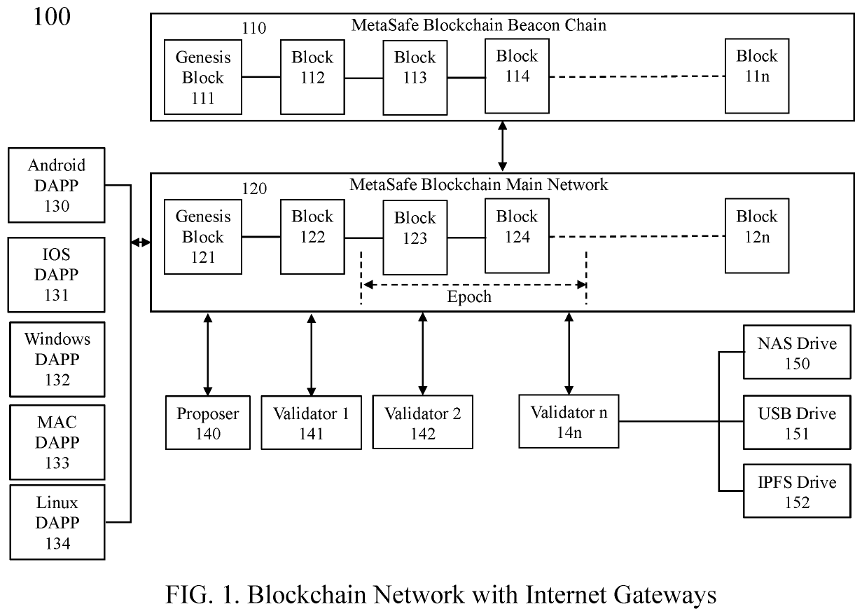

The systems and methods may be better understood through the illustrations of certain embodiments provided herein as illustrated by the drawings. Referring to FIG. 1, which illustrates in block diagram form an embodiment of the invention, the MetaSafe Blockchain system 100 comprises the Blockchain Beacon chain 110 which constitutes the genesis block 111 of the Beacon chain and one or more additional blocks 112, 113, 114 . . . 11n in the Beacon chain. Platform 100 further comprises the Blockchain main network 120 which is comprised of one or more Shards, each of these Shards having a genesis block 121 and one or more additional blocks 122, 123, 124 . . . 12n. FIG. 1 illustrates the creation of block 123 and 124 during a certain Epoch, the time period preset until the end of that Epoch in which the proposer was randomly chosen among all the nodes on the network and the various validator nodes are assigned to certain Shards. The nodes of the network are implemented by using internet gateways (routers) 140, 141, 142, . . . 14n as nodes of the Blockchain network interconnected through the network and available to the network to provide computational, storage and bandwidth resources to perform transaction on the network. Any of the nodes of the network may function as a proposer 140 or as validator nodes 141, 142, 14n. The Blockchain network is further accessible to the decentralized android application 130 running on a device with android operating system, decentralized IOS application 131 running on a device with IOS operating system, decentralized windows application 132 running on a device such as a personal computer with Windows operating system, decentralized MacOS application 133 running on a Mac device with Mac operating system, and decentralized Linux application 134 running on a device with Linux operating system. The various DAPPs can request storage of desired data securely on the Blockchain network or another transaction to be performed on the network by making a request for such a transaction to one of the Internet Gateways on the network. Apart from the internal storage available on the Routers 140, 141, 142 . . . 14n, the platform also provides support for expanded physical storage, such as NAS drive 150, or USB drive 151. Furthermore, FIG. 1 illustrates the system having access to distributed storage using Interplanetary File System, which is depicted in the figure as IPFS Drive 152. Any such external storage may be implemented at any node on the network similar to what is illustrated in FIG. 1 as connected to the router 14n. All these devices on the network are capable of communicating to each other through the network which may be implemented through use of ethernet and/or WiFi protocols.

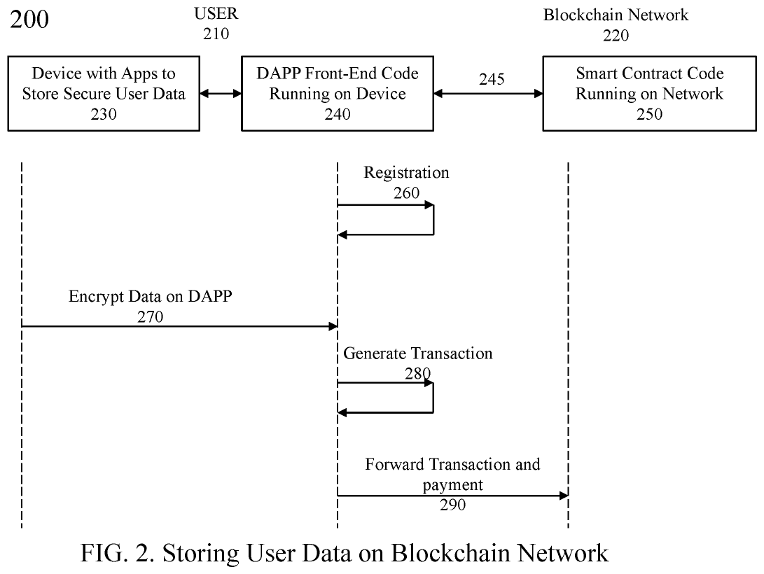

FIG. 2 illustrates the mechanism of storing some data on the Blockchain. The illustrated embodiment comprises a User 210 who desires to store some data on the Blockchain network 220 from User's device 230, which may be a computer, tablet, smart phone, etc., running a browser or other application that stores user data securely and is responsible to authenticate the user. The Device 230 may be running the front-end code of a decentralized application 240, which may be a Web3 App that provides a user interface to allow communication with the back-end code of the decentralized application 250 running on a router in the Blockchain network 220 by means of JavaScript Object Notation Remote Procedure Call (JSONRPC) or Web3 call 245. The blockchain network code 250 may be running on the decentralized peer-to-peer network 220 and may combine a smart contract with a front-end user interface.

Referring to FIG. 2, the user 210 will use the front-end of DAPP 240 to register 260 with the network using public and private key. Once registered, the data that needs to be stored in the blockchain is encrypted 270 on the DAPP and the request to store secure data is generated as a transaction 280 at the DAPP. This request is communicated to the Smart Contract code 250 running on a node on the network 220 through the JSOCRPC call 245 and the encrypted data is transmitted along with any required payment 290 in token form to the network where the data is stored in a distributed storage. Such storage is provided by the routers that make up the network nodes through internal flash storage or through externally connected NAS storage devices to such routers. The data is stored securely with the records for the transactions being added to the Blockchain after verification from the required validation nodes.

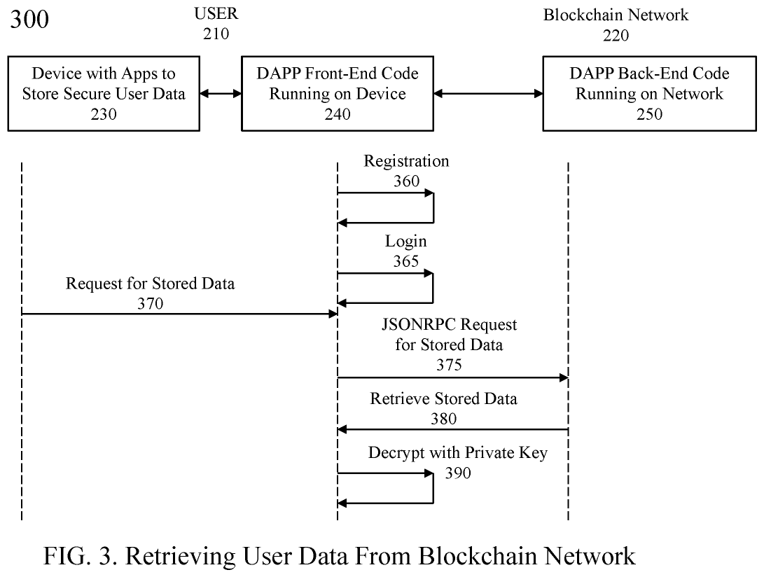

Now referring to FIG. 3, the figure illustrates the process of requesting and obtaining the data stored on the network by a user. The DAPP 240 registers 360 with the network using public and private key. The front-end of DAPP 230 may authenticate the user and may require the user to provide further login credentials to login 365. Once authenticated, the request to retrieve the stored secure data 370 is sent from the device to the DAPP 240 running on the device. This request is communicated to the DAPP back-end code 250 running on a node on the network 220 by means of JavaScript Object Notation Remote Procedure Call 375. The stored data is retrieved 380 by the front-end of DAPP 230 from the network storage by means of the DAPP back-end code running on network 250. The data is decrypted 390 by using the private key and provided to the user. Router owners may be incentivized by the users for the storage and for maintaining the blockchain network through payment of tokens for each transaction.

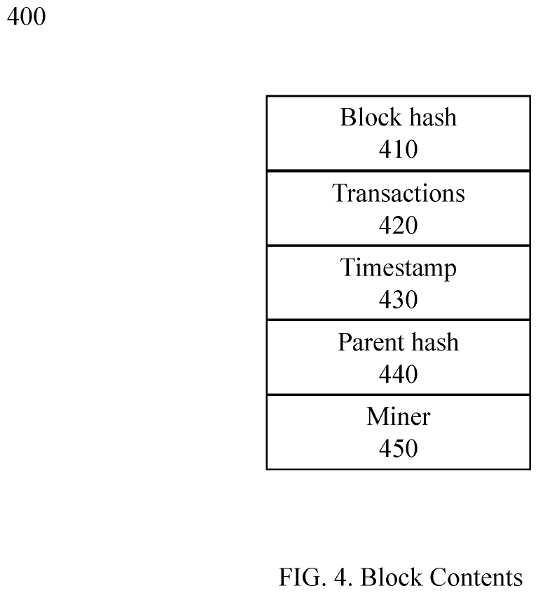

As depicted in FIG. 4, each block that is added onto the chain consists of “block hash”, “transactions”, “timestamp”, “parent hash”, “miner” and in other embodiments may also contain other data. Block hash is the hash value for the contents of that block. Transactions may further comprise the type of transaction, any associated Smart Contract and such other data, timestamp saves the actual time when the transaction was completed. Parent hash is the hash value for the parent block to which the current block was added on the Blockchain. Validators hold the information for the node that got the credit for verifying the transaction.

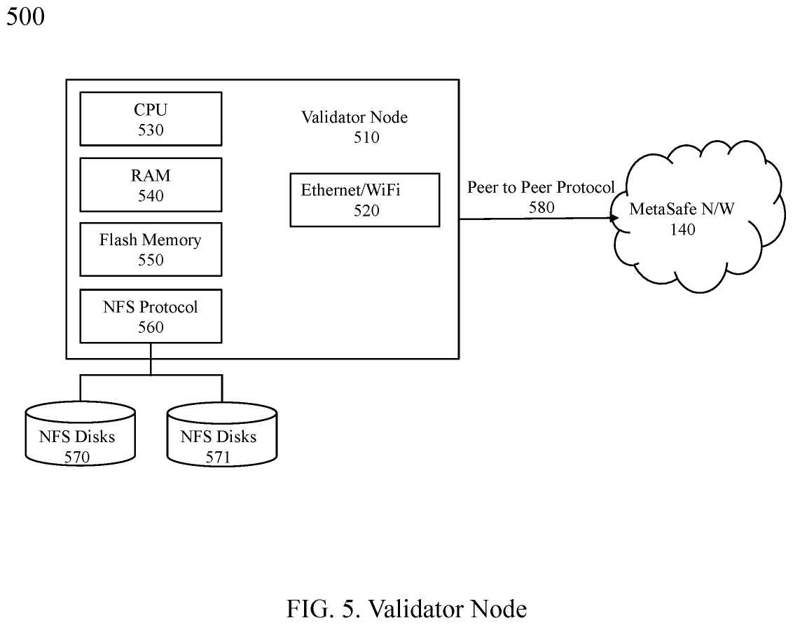

FIG. 5 illustrates the validator node components and connectivity in a block diagram form. The validator node 510 comprises of: connectivity module 520 which connects the node to the rest of the Blockchain network using a network interface such as ethernet or WiFi, a CPU 530 for executing code, the RAM 540, which is the memory used by the validator node for execution of code, flash memory 550, which is the internal memory to the node used to store the Blockchain information, and the network file system module 560 which implements the protocols for the validator node to connect to external storage available in network file system disks 570 and 571. The external storage in NFS disks 570 and 571 are used by the validator node to store the blockchain information if the internal storage available in flash memory 550 is not sufficient. Furthermore, the validator node environment depicts the connectivity to the MetaSafe Blockchain network 140 by implementation of a Peer to Peer protocol 580 interconnecting all the nodes on the network 140.

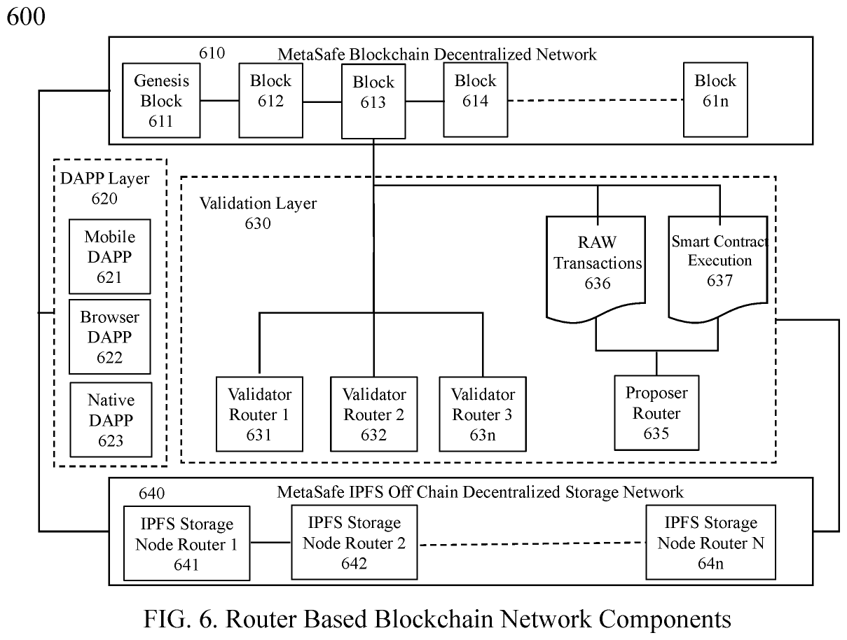

Referring to FIG. 6, which illustrates the components of an embodiment of a router based Blockchain network 600 which comprises a MetaSafe Blockchain Decentralized Network module 610, a DAPP layer module 620, a validation layer module 630 along with a MetaSafe IPFS Off Chain Decentralized Storage Network module 640. The MetaSafe Blockchain Decentralized Network module 610 further comprises a genesis block 611, which is the first block created on the Blockchain, in addition to additional blocks on the Blockchain 612, 613, 614 . . . 61n. Each of the additional blocks 612 onwards are added to the Blockchain on subsequent transactions after the genesis block has been created.

The DAPP layer module 620 further comprises a module depicting a decentralized app running on a mobile device 621, a decentralized app running in a browser on a device 622, and a native decentralized app 623. These DAPPs may provide specific features and services where the associated transaction data, Smart Contracts and other data associated with such services or features are saved on the Blockchain.

The validation layer module 630 further comprises the proposer router 635 which is the node randomly chosen as explained in other parts of this application to start a transaction along with multiple validation routers represented by 631, 631 and 63n. The proposed transaction on the network may be a raw transaction 636 or storing or retrieving data, execution of a Smart Contract 637, transfer of a MST between nodes, or some other type of transaction with the associated data being stored in a distributed fashion on various blocks of the Blockchain.

The MetaSafe IPFS Off Chain Decentralized Storage Network module 640 further comprises multiple IPFS Storage Node Routers 641, 642, to 64n. These routers may be providing storage for the data associated with a transaction on a decentralized storage network external to the Blockchain network by making use of IPFS in association with NAS disks or other storage media. The validation layer will request and access the data required to perform the validation of the transaction.

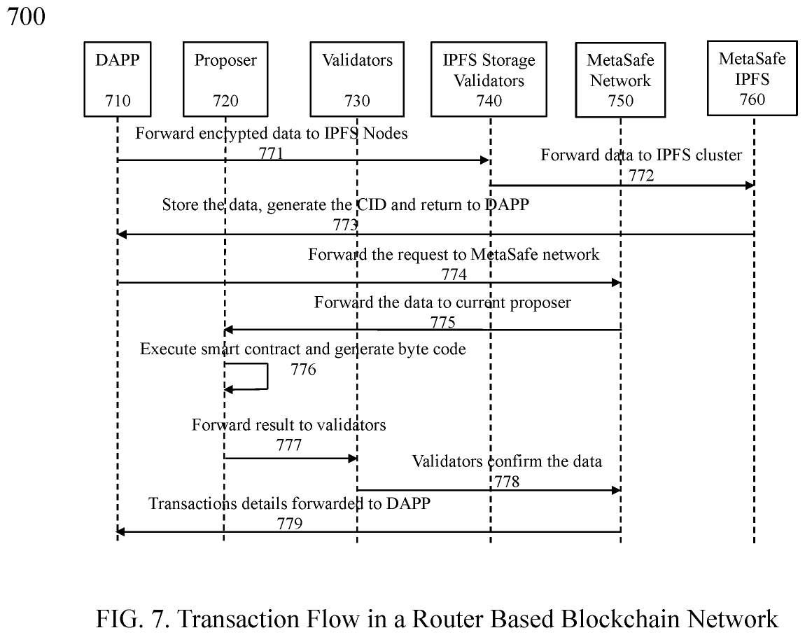

The steps involved in starting and completing a transaction and the on network and off network components that are part of such transaction can be better understood by referring to the flowchart in FIG. 7, which depicts the transaction flow in an exemplary embodiment of the present invention where a decentralized application initiates a transaction on the network. The exemplary embodiment in FIG. 7 comprises the DAPP 710, a proposer node 720, multiple validators 730, IPFS storage validators 740, along with the MetaSafe Blockchain network 750 and the MetaSafe IPFS module 760.

Referring to FIG. 7, at step 771, the DAPP 710 forwards the off-chain storage data to the IPFS storage validators 740. In the illustrated example, the data is being stored at an off-chain external storage implemented by using IPFS and step 772 illustrates the forwarding of this data MetaSafe IPFS 760. At step 773 the content identifier CID will be generated after the data is uploaded to the IPFS network and will be returned back to the DAPP. At step 774, the DAPP 710 forwards the CID to be stored in the MetaSafe network 750 Smart Contract to store persistently using the MetaSafe Blockchain network. At step 775 the request is forwarded to the current proposer 720. At step 776, the proposer executes the Smart Contract and generates the resultant byte code for the validators to verify and forwards the result to the validators 730 at step 777. Validators 730 confirm the data given by the proposer 720 and the block on the MetaSafe network 750 blockchain is sealed at step 778. At step 779, the Metasafe Network 750 send the transaction completion message along with the transaction data and details to the DAPP 710.

The off-chain storage data uploaded by DAPP 710 to be stored on the Blockchain could be credentials, personal information or any other user related information that is desired to be stored on the decentralized storage network 750. Transaction data further comprises the CID in encrypted form and is verified and stored on the MetaSafe Blockchain decentralized network to prevent tampering of that data.

In other embodiments, the MetaSafe validators 730 and IPFS storage validators 740 may exist on the same router (node) running simultaneously as two separate services, one targeting the Blockchain network and the other controlling the IPFS network.

In an embodiment, the MetaSafe Blockchain is designed to support 4 Shards in order to optimize the cost and performance. Shard 0 is the main chain or Beacon chain with 3 other Shards Shard 1, Shard 2, and Shard 3. As validators join the network, they are randomly assigned to a Shard. Then at each epoch, the validators may be randomly reassigned to a different Shard.

Beacon chain is the main chain of the MetaSafe network and responsible for selecting the validators on to the respective slots in the main chain and as well as the Shard chains. Beacon chain has the deposit contract in which the validators will be depositing or staking MST. Beacon chain may also keep track of the stake that an individual validator has staked on to the network and allocate rewards to the respective proposers when a block is added onto the chain. Beacon chain may also impose the slashing for malicious actors on the network and impose deductions for the nodes that do not stay online for a threshold or minimum time duration.

In the embodiment, Shard chains 1, 2, 3 are the parallel Blockchain networks that work with the Beacon chain to have horizontal scaling on the network database and also perform transactions in parallel to achieve better throughput on the network. In the embodiment, the MetaSafe Sharding implementation is PoS based and removes the requirement of each node holding the entire Blockchain, thus making the Blockchain scalable and secure.

Though the same account information and tokens may be working on all the Shard chains, the system is designed to be resilient to double spend problems and sybil attacks. Cross chain communications are implemented for the Beacon chain to communicate with the Shard chains and vice versa.

Cross chain communications and transactions may be synced with the following mechanisms: main chain sync mode, client-based sync mode, and chain-to-chain sync mode. In main chain sync mode, the main chain will be syncing the states between the Shard chains. Whenever a transaction or condition needs to update the state in another chain, the data will be sent to the main chain from the origination Shard chain and in turn the main chain will be performing the sync to the target Shard chain.

In client-based sync mode, the clients that are running the applications may handle the events and send the state information from one chain to another chain. The client applications may act as the bridge between the chains.

In chain-to-chain sync mode, the Shard chains may directly communicate with the target Shard chain to update the state information. Whenever a state change happens on one of the Shard chains and this state change must propagate to the next Shard chain, the details will be directly sent to the target Shard chain via remote procedure calls (RPC).

The consensus algorithm is a key component of any Blockchain. The algorithms decide how quickly and securely the network can reach a consensus to commit the next block. In the traditional Proof-Of-Work (POW) consensus process, miners compete to find the solution to a cryptographic puzzle, the winner proposes the next block and earns tokens as rewards. In this consensus protocol, the assumption is that more than 50% of the miners are honest nodes.

The embodiment of Metasafe discussed here uses the Practical Byzantine Fault Tolerance (PBFT) consensus algorithm that allows the network to reach a consensus even when a small number of nodes are faulty or dishonest. During the transmission, PBFT uses cryptographic algorithms, such as hash, to ensure that the information is immutable, and unquestionable. PBFT also optimizes the Byzantine Fault Tolerance (BFT) algorithm and brings down the computational complexity from exponential to polynomial. The essence of PBFT can be summarized as follows:

In a distributed system that constitutes 3f+1 nodes (f represents the number of faulty nodes or byzantine nodes), a consensus can be achieved successfully and honestly as long as no less than 2f+1 non-byzantine nodes are functioning normally. Each time the consensus protocol has to run, it starts with the Beacon chain electing one node as the “leader” and therefore the rest of the nodes are automatically assigned as “validators”.

Each round of consensus protocol consists of mainly two phases, the prepare phase and the commit phase. In the preparation phase, the leader sends his proposal to all the validators. Each of the validators in turn send their votes to everyone else. This ensures that all other validators count the votes of each validator. The preparation phase completes when more than 2f+1 votes are counted as consistent (where f is the number of malicious validators, and the total number of validators plus the leader is 3f+1) by each validator as well as the leader.

The commit phase is a similar vote counting process where the next block is created if consensus is achieved. Here also, the leader broadcasts the decision to all validators, who in turn rebroadcast the message to everyone and finally each validator and the leader see 2f+1 consistent votes to finish the commit phase.

Since in the embodiment of MetaSafe discussed here, the consensus is based on Proof-Of-Stake (POS), the consensus algorithm is modified further by allowing validators to have voting power that is proportional to their voting shares gained by staking. So, instead of counting for at least 2f+1 signatures from validators, the leader may actually count for signatures from the validators that effectively makeup at least 2f+1 voting shares.

Embodiments of the MetaSafe network may be implemented in two layers: “Consensus Layer” and “Execution Layer”. Consensus Layer may be responsible for handling all the Beacon chain related activities such as “coordination with execution layer”, “running epoch transactions”, “rewarding”, “slashing” and “validator selections for the next epoch”. The Execution Layer may be used to enable business use cases such as execution of Smart Contracts, transactions, encryptions, hashing, etc. that will be taking place on the Blockchain.

There is a bandwidth problem associated with standard PBFT. The rebroadcasting of votes to and from all the validators results in too many transmissions and this complexity may make the Blockchain network unsustainable with large number of validator nodes.

This embodiment of MetaSafe implementation avoids the rebroadcasting of PBFT by all the validators and thus eases the problem. This is achieved by adopting BLS (Boneh-Lynn-Shacham) multi-signature protocol, a variant of PBFT. BLS is a pairing-based cryptographic signature scheme that supports multiple validators signing their vote with a constant sized signature.

The BLS-modified PBFT consensus protocol works as follows:
a. The leader proposes the new block and sends the block header to all validators.
b. The validators validate the block header, sign it with a BLS signature, and send the signature back to the leader (without rebroadcasting to all validators).
c. The leader waits for at least 2f+1 (as per PBFT algorithm) consistent signatures from validators and aggregates them into a BLS constant-sized, multi-signature.
d. The leader sends the aggregated multi-signature to all of the validators.
e. The validators confirm that the multi-signature has at least 2f+1 signers, sign the received message, and send it back to the leader.
f. The leader waits for at least 2f+1 valid signatures from last step and aggregates them together into a BLS multi-signature.
g. Finally, the leader commits the new block with multi-signatures and sends the new block to all of the validators.

Consensus process utilizes the Beacon chain, which is the core of the MetaSafe network. Its main function is to store and manage the registry of validators. Validators are the nodes that have staked a minimum number of tokens to the deposit contract deployed on the MetaSafe Beacon chain and have enough storage and bandwidth.

The purpose of the Beacon chain with validator registry is as follows: assign validators, finalize checkpoints, perform random number generation, progress Beacon chain, link and vote on the transactions in Shard chains.

A slot is a set time frame for proposing the next block (in MetaSafe, a slot is 10 secs). A block is the storage space containing transactions, data, and Smart Contracts. A slot may or may not have any blocks to process. One epoch contains 14400 slots.

After each epoch, the available validators are randomly selected and merged to form new committees. One or more individual committees are required to attest the blocks. There are 127 committees and 1 proposer. The proposer is the node that proposes the block and the rest of the 127 committees containing one or more validators will attest the block. The process of selecting the validators and committees lies with the Beacon chain. It is responsible for randomly assigning the proposer and committees for each slot.

The embodiment of MetaSafe implementation of BLS/PBFT further implements a number of fault and attack tolerance mechanisms including mechanisms to prevent Sybill attack, Faulty Leader Node, Faulty Validator, Retransmission Node Loading, Unauthorized Shard Control, DDoS attack and Eclipse attack.

Sybil attack: In Sybil attack one entity assumes many identities and tries to gain control over the network. To prevent Sybil attacks various techniques are present such as “Identity Validation”, “Social Trust Graphs”, “Personhood validation”, “Economic costs,” etc. The embodiment of Metasafe uses Proof of Stake to prevent Sybil attacks. In the embodiment of MetaSafe discussed, if a node desires to be a validator, then the validator node must stake certain number of tokens. As the number of nodes in the network increases, to control the network or gain command over the network, the attacker must stake multiple tokens with multiple identities and must have at least 51% of the share. PBFT also counts the voting share instead of plain number of votes, thus creating a bias towards higher stake validators.

Faulty Leader Node: if a leader node is a faulty node whether it's trying to stall the communication or corrupt the communication, as observed in the PBFT algorithm, the leader can only perform this operation for a view time after which if a consensus is not arrived, then the leader simply will be ignored and the view will move forward to select a new leader and complete the task.

Faulty Validator Node: if in a committee, the validator node is not proposing a solution or corrupting the data, then as per PBFT if at least 2f+1 replies are coming from honest nodes, then the algorithm will continue to arrive at consensus. Even in scenario where there are more faulty nodes and consensus is not reached, this view may be discarded, and the validation move to the next view.

Retransmission Node Loading: during the PBFT phases the messages generated at each phase must be transmitted between leader and replica to arrive at a solution and vice versa. If faulty replicas are retransmitting the messages to overload the network, the other replicas can detect this based on the timestamp and BLS signature and may simply chose to ignore the message if there is timestamp duplication or if the BLS signature is invalid.

Unauthorized Shard Control: MetaSafe embodiment implements distributed validators across Shards and the validators are not always assigned to only one Shard. At each epoch the validators are randomly selected and grouped to form proposers and validators with committees for different slots until another epoch. This randomizes the validators and thereby prevents a bad node from gaining control over a particular Shard at any given time. Furthermore, cross-Shard communication is implemented with Shards directly communicating with each other. An atomic locking mechanism may be used to ensure the consistency of cross-Shard communications.

DDoS Attack: To prevent or address distributed denial of service (DDoS) attacks, a transaction fee is required in the Metasafe embodiment, where every transaction that alters the state of the blocks in the Metasafe network can only be done with a transaction fee associated with it. The attacker performing the attack must pay the transaction fee for each transaction, without which the nodes receiving it will reject the transaction and will not allow the transaction to propagate onto network for finality.

Eclipse attack: A node in a network of X nodes using Peer to Peer strategy will need to connect to the respective X nodes to sync the blocks and view its ledger. If the attacker is able to control X nodes then the node trying to sync the blocks will be seeing completely different information than the correct one. Metasafe prevents the eclipse attack by regularly generating the Kademlia routing table at a certain time interval which will randomize the nodes to which the current node is communicating with. Due to this randomization, if the attacker manages to temporarily control all nodes to which the current node is communicating, the transaction can still be recovered in the next interval by verifying its chain data.

At every epoch, certain numbers of validators are assigned to a Shard to create the next block. The validators are picked randomly based on a protocol that is unpredictable, unbiased yet verifiable, and scalable. The primary characteristics of the random number generation process are that no one should be able to predict the random number or influence the generation of random numbers. It is also important that the validity of the random number is verifiable by anyone, and the solution should work when large numbers of validator nodes are present.

MetaSafe utilizes Verifiable Random Function (VRF) and Verifiable Delay Function (VDF) to implement Distributed Randomness Generation (DRG) algorithm to pick the validators. The entire system works by selecting a leader at random and the leader will construct an initial message with a hash of the previous block. This message will be sent to all the validators. After the validator receive this message, VRF is computed to create a random R and the proof P as follows:

(Ri,Pi)=VRF(Ski,H(Bn−1),v)
where,
i—validator node that is computing the VRF
Ri—random value from i validator node
Pi—Zero Knowledge Proof (ZKP) from i validator node
VRF—Verifiable Random Function
Ski—Private key of the i validator node
H(Bn−1)—SHA3 of the previous block
v—the current view number of the current epoch.

After the validators generate the random value, the leader will wait for f+1 replies from the validators, where f is the total number of faulty nodes according to the PBFT algorithm. Once the responses are received from the validators, Prnd will be computed as follows:
Prnd=XOR(r0, r1, r2, r3, . . . rn) where n=3f+1 nodes and the total replies are f+1.

The leader then runs PBFT among all the validators to reach a consensus on the Prnd and commit the Prnd in block n. After Prnd is committed, the leader will start the actual randomness computing Rnd=VDF(Prnd, T). T is the difficulty and is set algorithmically such that randomness can only be computed after a random k number of blocks. Once Rnd is calculated, the leader initiates PBFT among all validators to agree on the validity of Rnd and commit the Rnd into the chain.

VRF has three stages:
a. Keygen(r): (Pk, Sk) where Pk is the public key and Sk is the private key using BLS key generation algorithm.
b. Compute(Sk, M): Hash(Sign(Sk, M))->(R, P) where R is the hashing of the signature signed with Private key Sk of message M and P is the VRF proof which is equal to the sig-nature from Sign(Sk, M).
c. Verify(Pk, M, R, P): SignatureVerify(Pk, P, M)=True & Hash(P)=R

VRF is achieved via a precompiled Smart Contract present in the chain. For determination of VDF a delay is added to a Proof of Stake consensus algorithm to prevent malicious validator from predicting the randomness and influencing the decision of mining a block.

MetaSafe epoch interval is the time interval at which certain tasks such as adding new validator nodes to the chain, reassignment of the validators to each Shard, and incentives are paid out. In an embodiment, Epoch time may be selected to be every 14400 slots. With 6 seconds per slot, this will span 24 hours. In certain other embodiments, this epoch time interval value may be defined at the genesis block and may be fixed for a duration of time such as for a month. After the first epoch, the current validators may propose a new epoch time interval. If a majority of the validators (N/2+1 validators) vote for a new epoch time interval, then the new epoch time interval is accepted and will take effect immediately in the next cycle. If the number of votes does not reach N/2+1 then the epoch interval time will remain as is for the duration of one more epoch duration and will again be eligible for voting at the end of that epoch.

At the start of each epoch, new validators may be added to the network and assigned to a Shard. The existing validators will be reassigned to their new Shard for this epoch. The assignment of the validators will be done based on a distributable random number generator DRN function. In this process, a leader validator node will be selected based on the current leader selection algorithm. After this process is done, the leader will broadcast two large unsigned integer values M and N, where M is less than N and M is not equal to N, to all the nodes. After all the validators receive these two numbers, they will pick a random number X. The validator node will calculate the hash value for verification purposes using its private key and public key as the hash. Hash(V-Rand, Private Key) and Hash(V-Rand, Public Key). These values along with the validator's public key and a random number will be broadcasted in the network. The leader node will be waiting for a predefined time and after that, the leader will broadcast the slot ranges into which the random numbers will be residing and will commit this information into the block along with the random numbers chosen by the validators. Once these values are committed then the validator nodes will check the respective ranges committed in the block and will join the appropriate Shard.

This allocation can be verified by anyone using Hash(V1(Rand), Public Key) and V1(Rand). If someone joins the wrong Shard then it can be easily detected.

The MetaSafe Network may further implement fault tolerance mechanisms in case the leader node does not select the slot ranges within the predefined time interval, then the entire process may be reinitiated by selecting a new leader and imposing the penalty on the previous leader node by taking away the staked tokens. Furthermore, if any of the validator nodes modify the secret random number after the broadcast is done, then it can be easily detected with the block data containing the secret random numbers from the validators. If this is detected, a penalty may be imposed on the respective validator node by taking away staked tokens. Additionally, if a validator node does not broadcast the random numbers within the time interval defined in the network, then the validator node may be removed from participating in the next epoch interval. Token penalty may not be assigned in this context because the node might be temporarily experiencing network issues or other unforeseen issues. The particular node can participate again at the start of the next epoch.

At each epoch, before the validators are assigned their Shard, MetaSafe incentives may be paid out to each of the nodes based on predetermined rules for earning utility tokens and staking of tokens for various transactions on the network. The leader node selected to perform the epoch operation will also pay out the necessary fees collected for each transaction to the validator nodes that validated those transactions in the form of MetaSafe utility tokens.

In addition, at each epoch, a majority of the actual fiat collected for applications built on top of the MetaSafe Blockchain may be credited to the validators in proportion to the amount of MST they staked to the total MST staked on the MetaSafe network.

Validator nodes are the main workhorses of the MetaSafe network. These are the nodes operated by the community of validators running and maintaining the MetaSafe network, providing peer-to-peer connections and secure storage. These are the computing systems that help in proposing the new blocks, selecting the validators at epoch, enforcing the slash rules, maintaining the database of the MetaSafe network, offer peer to peer connectivity, performing cross-chain transactions, executing the Smart Contracts, etc.

MetaSafe network, being a decentralized network designed to run on low cost processors that communicate among themselves using certain protocols, uses Peer-to-Peer mechanism for network communications, where the nodes will do discovery by connecting to boot nodes or Beacon nodes. MetaSafe network nodes may work on both IPv4 and IPv6 with transport protocols supporting over TCP, UDP, Quic, etc. Decentralized Apps (DAPP) may interact with the MetaSafe Network using Web3 or JSON RPC protocols. DAPPs may also interact with the network using HTTPS connections and web socket connections if the node is configured to serve these connections.

The storage required for the MetaSafe network may be available on the nodes or off the nodes. IPFS protocols may be used to store the data in IPFS drives and extend the storage in a random and distributed fashion for off-chain storage. NFS protocol may be used to extend storage for on-chain storage. Only encrypted references to the off-chain storage location and its meta data are stored on the MetaSafe Blockchain. Off-chain storage allows for information to be stored in a more efficient manner than on Blockchain.

Method and systems to create a decentralized storage and peer-to-peer network with relatively lower computing, storage and bandwidth requirements that enables anyone with an Internet connection to store their information securely from any computing device and privately retrieve it on demand or share it at will are described. Although specific embodiments are illustrated and described herein, it will be appreciated by those of ordinary skill in the art that any arrangement, which is calculated to achieve the same purpose, may be substituted for the specific embodiments shown. This application is intended to cover any adaptations or variations. For example, although an embodiment described to implement password manager with encrypted, secure and distributed storage of passwords, accounts, credit cards, and use ID's has been described herein, one of ordinary skill in the art will appreciate that the disclosed subject matter is applicable to other environments, such as, health data management including health records, diagnoses, and lab results. Other implementations of the disclosed inventions may utilize the secure verification and reward schemes to provide bandwidth sharing systems for secure access and pass through data services for a small fee in the form of MST or a decentralized VPN using tor-like techniques to provider a secure and private traffic relay system.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments.

We claim:

1. A system comprising:
a router;
a Blockchain network implemented by using the router as a node of the Blockchain network to store Blockchain data;
wherein, the router further comprises:
a random access memory;
a persistent storage medium;
machine instructions stored in the persistent storage medium;
a computer processor capable of executing machine instructions in the random access memory;
wherein, the computer processor executes the machine instructions to perform tasks on the Blockchain network; and
the persistent storage medium in the router is used to store the Blockchain data.

2. The system of claim 1, further comprising a network attached storage connected to the router to store the Blockchain data.

3. The system of claim 1, further comprising a decentralized application to provide a service to a user to securely store a user data on the Blockchain network.

4. The system of claim 3, wherein the user data stored on the Blockchain network is one of: a login credential, an address, credit card information, a user ID, a password and an account information.

5. A method of implementing a Blockchain network using always connected router wherein the router is providing computing resources, storage, and network bandwidth.

6. A method of claim 5, wherein the Blockchain network is implementing proof of stake algorithm to incentivize an owner of the router.

7. A method of claim 5, wherein the Blockchain network is storing, updating, and retrieving personal data of a user.

8. The method of claim 5, wherein the router is providing storage in exchange for user providing an incentive to an owner of the router.

9. The method of claim 5, wherein the router is providing storage in exchange for user providing an incentive to an owner of the router.

10. The method of claim 8, wherein the router is providing storage for encrypted user data.

11. The method of claim 8, wherein the Blockchain router is providing storage on internal memory of the router and on network attached storage connected to the router.

12. The method of claim 8, wherein the Blockchain router providing storage supports interplanetary file system.
